(19) United States
(12) Patent Application Publication
(10) Pub. No.: US 2015/0343865 A1
(43) Pub. Date: Dec. 3, 2015

(54) Safety Enhanced Turntable or Fifth Wheel for Coupling a Semi-Trailer to a Prime Mover

(71) Applicant: Tumtable Safety Devices Australia Pty Ltd, Victoria Point West (AU)

(72) Inventors: John Hile, Withcott (AU); Garry John Cook, Redland (AU)

(21) Appl. No.: 14/485,212

(22) Filed: Sep. 12, 2014

(30) Foreign Application Priority Data
May 29, 2014 (AU) 2014202922

(51) Int. Cl. B60D 1/36; B60D 1/01

(52) U.S. Cl. CPC B60D 1/36; B60D 1/015

(57) ABSTRACT

A method for assisting in the coupling of a semi-trailer to a turntable of a prime mover includes remotely monitoring sensors about the turntable to make a number of determinations. These include that the semitrailer is suitably close to the turntable for correct coupling. That a locking member, e.g. a kingpin, of the semitrailer is correctly positioned relative to the turntable for proper coupling. That a kingpin locking mechanism of the turntable is in a locked configuration. The result of the determinations is indicated to an operator of the prime mover.

The present invention claims priority to Australian Patent Application No. 2014202922 filed May 29, 2014, which claims priority to Australian Patent Application No. 2013901979 filed Jun. 2, 2013.

### TECHNICAL FIELD

The present invention relates to a turntable such as is found on a prime mover for coupling a semi-trailer thereto. Such coupling arrangements are typically called “turntables” in some countries, such as Australia and New Zealand and may be referred to as “fifth wheel” in the USA and other countries.

### BACKGROUND

The discussion of any prior art documents, techniques, methods or apparatus is not to be taken to constitute any admission or evidence that such prior art forms, or ever formed, part of the common general knowledge.

Heavy road transport vehicles, such as semi trailers and “double B” trailers are used for cargo road transport all over the world. Consequently, it is imperative that these vehicles travel in a safe fashion without imperiling their drivers, other road uses, cargo and valuable equipment.

As shown in FIG. 1, the coupling of a semi-trailer 2 to a prime mover 6 typically engages mating the king pin 8 to the prime mover's fifth wheel or “turntable” 4 as it will be referred to herein.

FIG. 2 depicts a typical prior art turntable 4 in more detail. The turntable 4 includes a top plate 16 with opposed pin guides 10, 12 which define an entry channel between them that leads to a central pin locking aperture 14. The top plate 16 tilts about a pivot 18 relative to a baseplate 20. A locking bar 24 and handle 22 extends from a side of the top plate 16. The locking bar 24 is coupled to an internal locking mechanism including locking jaws (not shown) for locking the king pin 8 within the locking aperture 14. In order to lock the king pin 24 within the locking aperture 14 the locking bar 24 is pushed via locking handle 22 to a locking position in which it makes the locking jaws lock about the king pin.

However, for a number of reasons the coupling of a prime mover to a turntable is problematic. In particular, there is a continuing issue of semi-trailers becoming inadvertently disconnected from the turntable and hence from the prime mover so that the leading end of the semi-trailer falls to the ground with resultant adverse results. In some cases the adverse results may be disastrous. For example, it has been known for semi-trailers to become disconnected from a turntable after having traveled in an apparently secure fashion for hundreds of kilometers before a failure in the coupling has occurred.

The inventors are aware of at least four reasons for an inadvertent turntable disconnect occurring:

The turntable load carrying surface, i.e. the top plate 16 and the semi-trailer skid-plate may not have been positioned against each other correctly as a result of the prime-mover's airbags not having been inflated correctly. Alternatively, the top plate and the semi-trailer skid-plate may not have been positioned against each other correctly because the semi-trailer's landing legs (item 26 of FIG. 1) have not been positioned correctly to bring the skid-plate and the top plate into correct alignment. In either case, the kingpin 8 of the semi-trailer 2 will not have been brought into the locking aperture 14 to its proper depth.

The turntable locking bar and handle is not seated correctly so that the locking jaws open under load.

The trailer kingpin may be seated in the locking jaws of the turntable but nevertheless the jaws may not have actually locked correctly.

The trailer king-pin has hit and closed the locking jaws of the turntable during the coupling process, indicating visually that the turntable jaws are correctly locked; however, the king-pin is not seated in the turntable jaws. In this case the pin can be jammed between the turntable housing and jaws, providing a satisfactory tug-test result, but eventually allowing the semi-trailer to simply fall off the prime mover.

It is an object of the present invention to provide an improved turntable that addresses one or more of the previously described problems

### SUMMARY OF THE INVENTION

According to a first aspect of the present invention there is provided a turntable assembly for coupling a prime mover to a trailer including:

a locking sensor arranged to sense that a locking mechanism of the turntable is in a locked configuration; and

a user interface located remote from the locking sensor and in communication therewith;

wherein the communication interface is arranged for indicating that the locking mechanism has assumed the locked locked configuration to an operator.

In a preferred embodiment of the invention the locking sensor comprises a locking handle sensor that is arranged to sense the position of a locking handle that operates the locking mechanism.

In a preferred embodiment of the invention the turntable further comprises a kingpin sensor arranged to sense location of a kingpin within the turntable at a position for correct coupling.

The king pin sensor is preferably in communication with the user interface.

Preferably the turntable further includes a trailer sensor which is arranged to sense a portion of a trailer in proximity to the turntable for coupling thereto.

Preferably the trailer sensor comprises a tilt sensor arranged to sense a tilt of the turntable associated with a coupling status of the turntable.

The tilt sensor is preferably in communication with the user interface.

Any one or all of the said sensors are preferably in communication with the user interface by means of suitable electrical cables. Alternatively, in other embodiments of the invention said sensors may be coupled to the user interface by a wireless link.

In one embodiment of the invention the user interface comprises at least one visual indicator. For example the user interface may comprise at least one light source. Preferably, a number of differently colored light sources are provided. For example, the differently colored light sources may comprises red and green LEDs or bezels. Furthermore, the user interface may include at least one audible alert source. The at least one audible alert source may comprise a buzzer or loudspeaker.

Preferably the user interface is mounted to, or integrated with, a dashboard of a prime mover to which the turntable is attached.

In a preferred embodiment of the invention said light source and said audible alert source are coupled to said sensor(s) by control circuitry wherein the control circuitry is arranged to operate said light source and said alert source until said sensor(s) indicate correct coupling of the kingpin with the turntable.

In a preferred embodiment of the invention the control circuitry comprises at least one relay. However, in other embodiments of the invention the control circuitry may comprise a suitably programmed electronic controller.

In other embodiments of the invention the control circuitry may be arranged to respond to sensors of the semi-trailer braking system whereby brakes of the trailer may only be released upon the sensors indicating a correct coupling of the kingpin with the turntable.

Furthermore in another embodiment of the present invention the control circuitry may be arranged to interface with an engine management system of the prime mover whereby an engine of the prime mover is prevented from operating at greater than idling speed whilst the sensor(s) indicate incorrect coupling.

According to a further aspect of the invention there is provided a coupling monitoring system for a turntable of a type used to couple a prime mover to a trailer, said monitoring system including:

a locking sensor arranged to sense that a locking mechanism of the turntable is in a locked configuration; and

a user interface located remote from the locking sensor and in communication therewith

wherein the communication interface is arranged for indicating that the locking mechanism has assumed the locked configuration to an operator.

In a preferred embodiment of the invention the locking sensor comprises a locking handle sensor that is arranged to sense the position of a locking handle that operates the locking mechanism.

In a preferred embodiment of the invention the turntable further comprises a kingpin sensor arranged to sense location of a kingpin within the turntable at a position for correct coupling.

The king pin sensor is preferably in communication with the user interface.

Preferably the turntable further includes a trailer sensor which is arranged to sense a portion of a trailer in proximity to the turntable for coupling thereto.

Preferably the trailer sensor comprises a tilt sensor arranged to sense a tilt of the turntable associated with a coupling status of the turntable.

The tilt sensor is preferably in communication with the user interface.

Any one or all of the said sensors are preferably in communication with the user interface by means of suitable electrical cables. Alternatively, in other embodiments of the invention said sensors may be coupled to the user interface by a wireless link.

In one embodiment of the invention the user interface comprises at least one visual indicator. For example the user interface may comprise at least one light source. Preferably, a number of differently colored light sources are provided. For example, the differently colored light sources may comprises red and green LEDs or bezels. Furthermore, the user interface may include at least one audible alert source. The at least one audible alert source may comprise a buzzer or loudspeaker.

According to a further embodiment of the present invention there is provided a method for assisting in the coupling of a semi-trailer to a turntable of a prime mover including:

remotely monitoring sensors about the turntable to:

determine that the semitrailer is suitably close to the turntable for correct coupling;

determine that a locking member of the semitrailer is correctly positioned relative to the turntable for correct coupling; and

determining that a kingpin locking mechanism of the turntable is in a locked configuration;

wherein the result of the determinations is indicated to an operator of the prime mover.

### BRIEF DESCRIPTION OF THE DRAWINGS

The Detailed Description is not to be regarded as limiting the scope of the preceding Summary of the Invention in any way. The Detailed Description will make reference to a number of drawings as follows:

FIG. 1 is a diagram showing a semi-trailer aligned for coupling with a prior art turntable of a prime mover.

FIG. 2 is an image of a prior art turntable.

FIG. 3A is a diagram of a turntable assembly according to a preferred embodiment of the present invention.

FIG. 3B is a diagram showing the turntable assembly with its locking mechanism in an unlocked configuration.

FIG. 3C is a diagram showing the turntable assembly with its locking mechanism in a locked configuration.

FIG. 4 is a wiring diagram of a turntable coupling monitoring system according to a preferred embodiment of the present invention.

FIG. 5 is an image of the turntable coupling monitoring system of FIG. 4.

FIG. 6 is a view of the front of a user interface of the turntable monitoring system of FIG. 5.

FIG. 7 is a view of the internal components of the user interface of FIG. 7.

FIG. 8 is a view of the internal components of a junction box of the turntable monitoring system of FIG. 5.

### DETAILED DESCRIPTION OF PREFERRED EMBODIMENTS

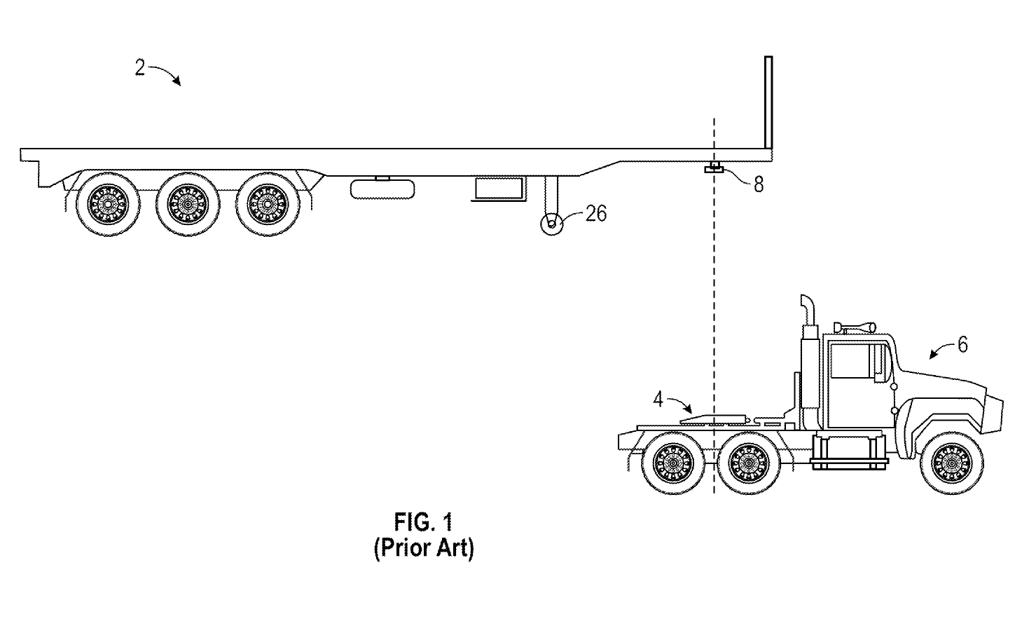

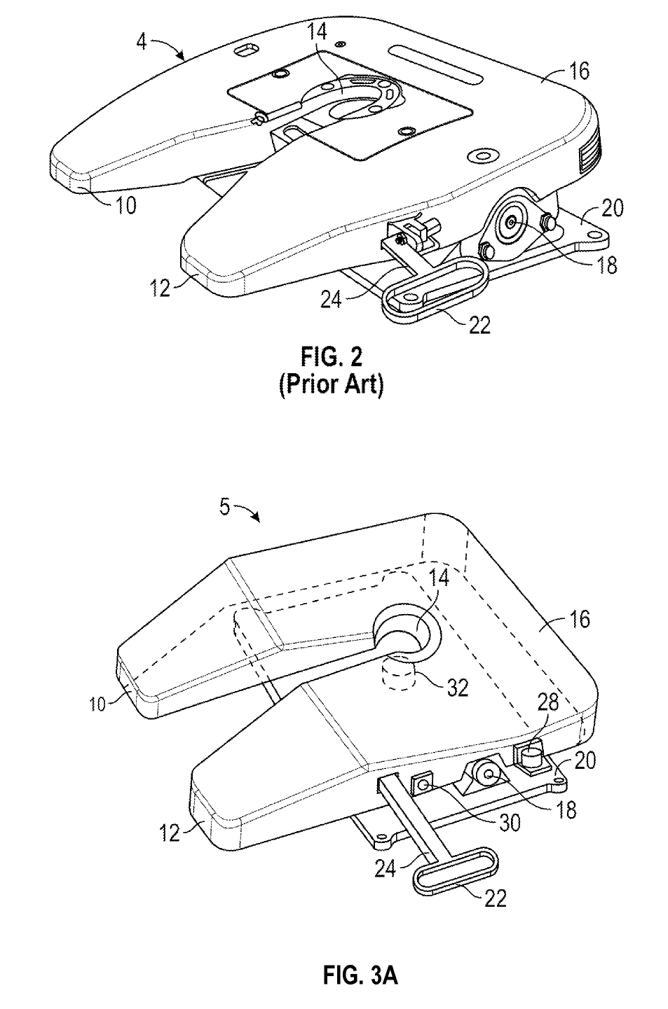

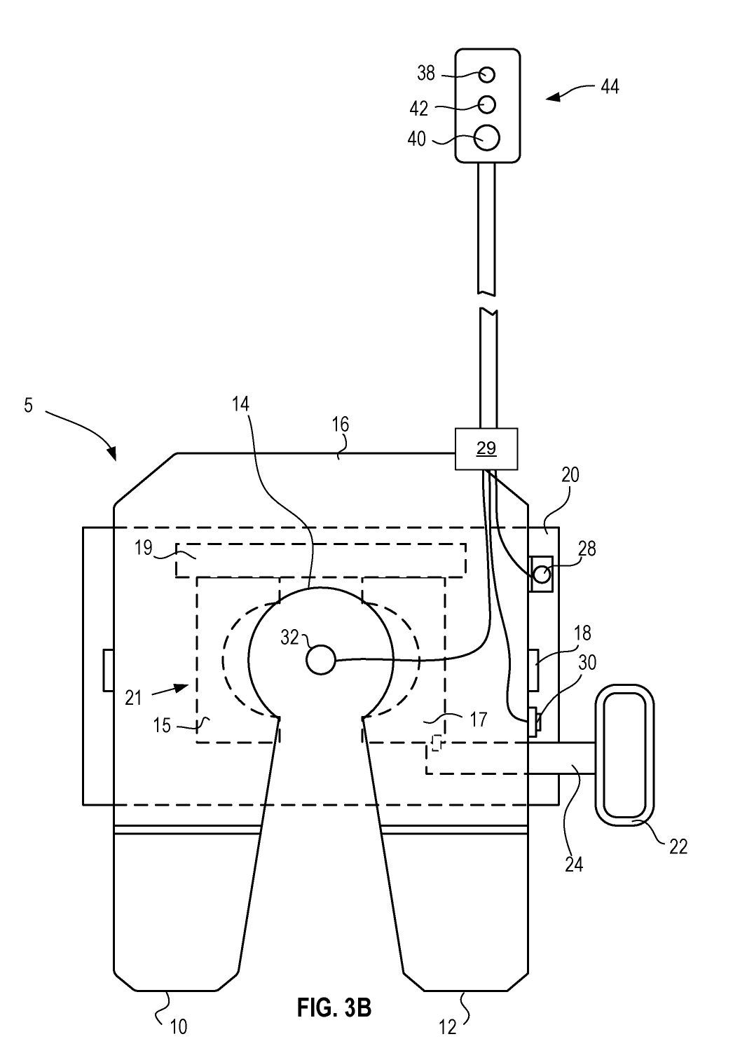

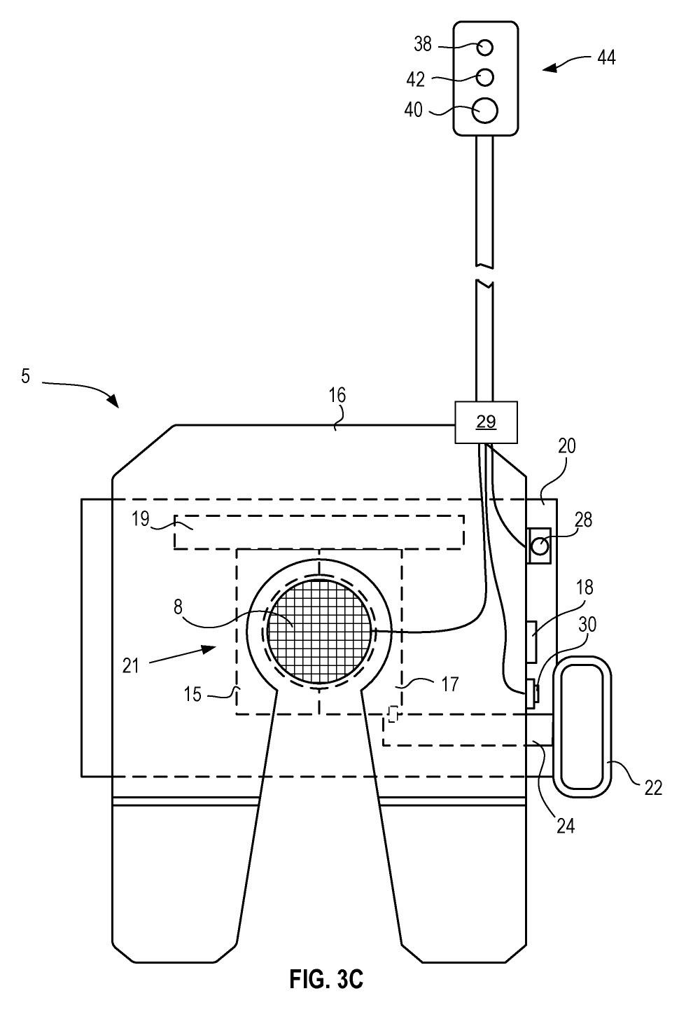

Referring now to FIG. 3A, there is depicted a turntable according to a preferred embodiment of the present invention for coupling a prime mover to a trailer. The turntable 5 includes a kingpin sensor 32 that is arranged to sense the presence of a kingpin, e.g. kingpin 8 of the trailer of FIG. 1, received at a coupling location of the turntable. The coupling location is deemed to have been reached when a lower portion of the kingpin is located above the kingpin sensor which is itself located coaxial with the locking aperture 14.

The turntable 5 also includes a locking sensor in the form of locking handle sensor 30, which is arranged to sense when the locking handle 22 is in a locked position and thus when the locking mechanism 21 is in the locked configuration that is illustrated in FIG. 3C.

A trailer sensor in the form of tilt sensor 28 is also provided on a bracket that is fastened at the side of the top plate 16. The tilt sensor 28 is arranged to sense the tilt of the turntable associated with a coupling status of the kingpin. More particularly, the tilt sensor 28 senses when the tilt angle between the sensor 28 and the baseplate 20 indicates that a skid plate of the semi-trailer is properly located on the top plate 16 as it will be when conditions for proper coupling between the king pin and the turntable exist.

FIG. 3B is a top plan view of the turntable assembly comprising the turntable 5 the sensors 28, 30 and 32 and wiring therefrom to interface box 44. The interface box 44 includes an audible indicator 40 and also visual indicators 38 and 42 which are responsive to the state of the sensors and which will be discussed further shortly. In FIG. 3B a locking mechanism 21 is illustrated which is comprised of opposed jaws or “yokes” 15 and 17 and associated mechanical coupling 19, which is shown in stylized form. The locking mechanism can be brought, by means of handle 22 and shaft 24, from the unlocked configuration shown in FIG. 3B, wherein the king pin can be introduced and released to and from the turntable, to the locked configuration shown in FIG. 3C wherein the jaws are closed about the king pin 8. It will be realized those skilled in the art that such turntable locking mechanisms are well known in the art and that the particular example that is illustrated herein is only one type that might be used in a turntable. Consequently, the present invention is not limited to any particular type of kingpin locking mechanism.

FIG. 3C is a further top plan view of the turntable assembly wherein the locking assembly 21 has been brought to a locked configuration by operation of the handle 22. In this configuration the tilt sensor 28, handle sensor 30 and king pin sensor 32 (shown in FIG. 3B) are all activated.

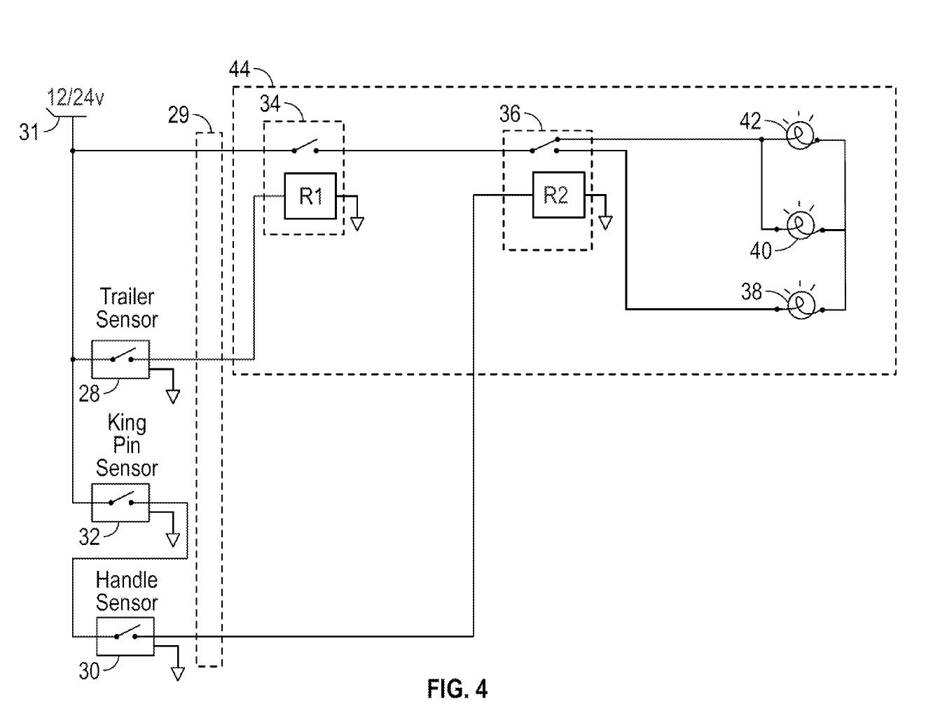

Referring now to FIG. 4 there is provided a wiring diagram showing the interconnection of the various sensors 28, 30 and 32 to the user interface 44 via a straight-through junction box 29.

The tilt sensor 28 is in parallel to the series combination of the king pin sensor 28 and the handle sensor 30. Upon the tilt sensor 28 sensing that the top plate 16 is properly tilted relative to the base plate 20, thereby indicating the presence of the semi-trailer skid plate on or just above the top plate 16 of the coupler 5, the tilt sensor 28 goes closed circuit. As the tilt sensor 28 goes closed circuit it thereby energizes the relay 34 so that the sensor side of the relay 36 is coupled to the power rail 31.

It will be observed that the king pin sensor 32 and the handle sensor 30 are placed in series connection. Consequently the king pin sensor 32 must detect the presence of the king pin and also the handle sensor 30 must detect that the handle is in the properly locked position before they both go closed circuit. It is only when both sensors 32 and 30 have gone closed circuit that relay 36 is placed in connection with the power rail 31 and thereby energized.

In use, as the prime mover reverses the top plate of the turntable encounters the skid plate of the semi-trailer. This causes the top plate 16 to tilt about pivot 18 so that the tilt-sensor 28 comes into proximity with base plate 20 and thereby goes closed circuit. As a result the relay 34 goes from open circuit to closed circuit thereby placing the LED and red light source 42 and the buzzer 40 in circuit with the power rail 31. Consequently, the red light shines and the buzzer sounds.

The operator then lowers the kingpin into the locking aperture of the turntable. This may be done by the operator deflating airbags on the semi-trailer as is known in the prior art. Once the kingpin has reached the correct locking depth its presence is sensed by the kingpin sensor 32 which then goes closed circuit. However, that of itself does not stop the red light 42 and buzzer 40 from continuing to shine and sound an alert since it does not alter the state of the relay 36.

The operator then manipulates the handle 22 so that it assumes its correct locking position whereby the locking jaws lock about the kingpin. As the handle 22 assumes its correct locking position it is sensed by the handle sensor which then goes short circuit thereby placing relay 36 in connection with the power source via the closed circuit kingpin 32. The energized relay 36 then switches from its non-energized position to its energized position wherein the green light source 38 becomes energized and glows. At the same time the red light source 42 and the buzzer 40 are de-energized and so stop lighting and sounding.

It will therefore be realized that in a preferred embodiment of the invention all three of the following conditions must be met:

1. The tilt sensor senses that the prime mover top plate is located against the skid plate of the semi-trailer to ensure that a satisfactory coupling can be effected.

2. The kingpin sensor senses that the kingpin is seated correctly within the turntable.

3. The handle sensor senses that the locking handle is properly located for the locking jaws of the turntable to be locked about the kingpin.

Only when all of the above functions are correctly completed will the driver receive a positive signal that correct coupling has occurred. If any one of the sensors indicates a non-coupling status in respect of the parameter that it measures then the red light and buzzer will come back on to immediately alert the operator that there is a coupling problem.

Consequently an embodiment of the present invention involves remotely monitoring sensors about the turntable to determine that the semitrailer is correctly coupled to the turntable. This involves determining that the trailer is suitably close to the turntable for correct coupling, e.g. by monitoring the tilt sensor. The method also includes determining that a locking member (e.g. the kingpin) of the semitrailer is correctly positioned relative to the turntable for correct coupling, by monitoring the kingpin sensor. Finally the method includes determining that a kingpin locking mechanism (e.g. the locking jaws) of the turntable is in a locked configuration by monitoring the handle sensor.

The results of the determinations are indicated to an operator of the prime mover, e.g. the driver, by the user interface box.

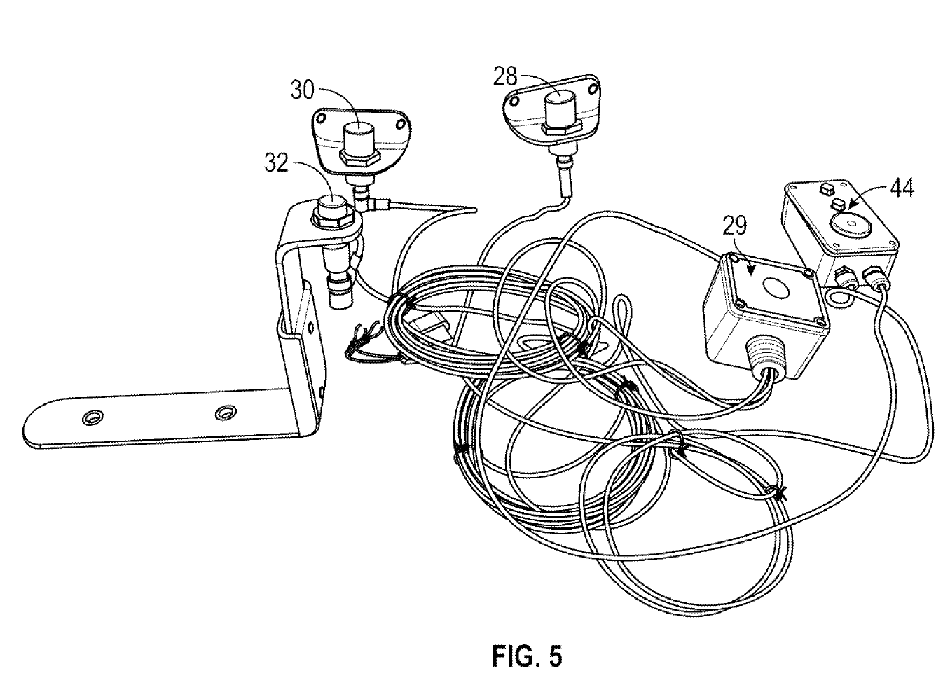

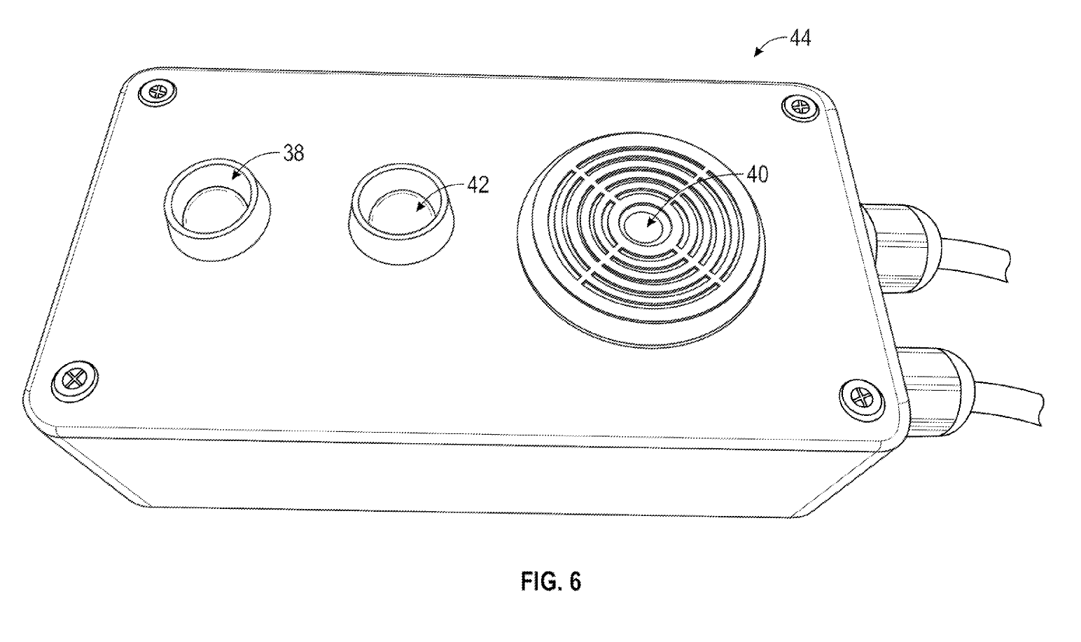

FIG. 5 shows a coupling monitoring system for a turntable according to a preferred embodiment and in accordance with the wiring diagram of FIG. 4. It will be noted that each of the magnetic proximity sensors 29, 30 and 32 are fastened to mounting brackets which are in turn secured about a turntable as previously described. The kingpin sensor 32 is mounted on a height adjustable bracket in order that it can be height adjusted to accommodate kingpins of varying length.

FIG. 6 is a view of the outside of the user interface box 44 showing the red 42 and green 38 light sources and the buzzer 40 referred to in the wiring diagram of FIG. 4.

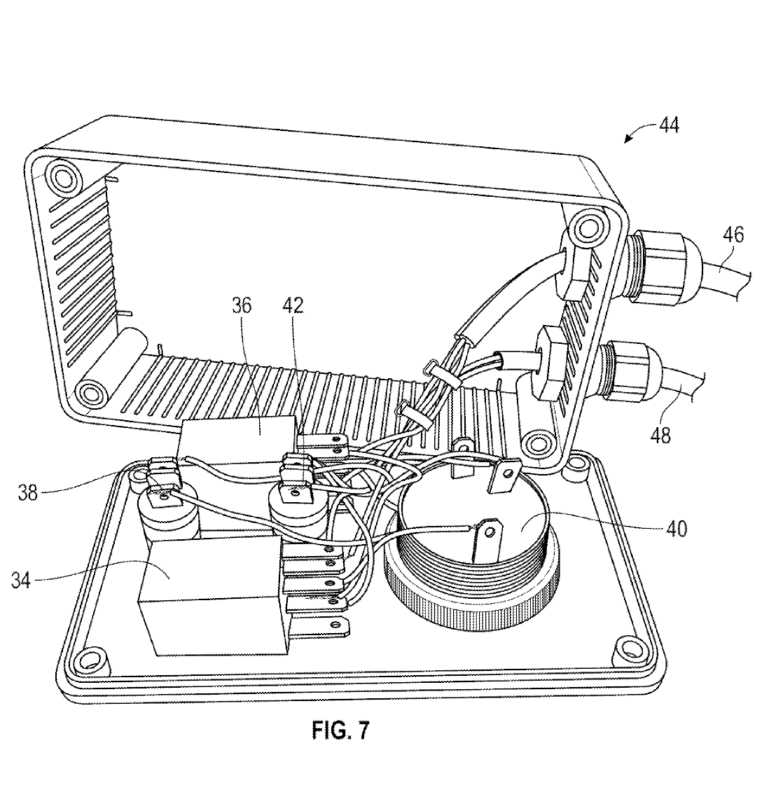

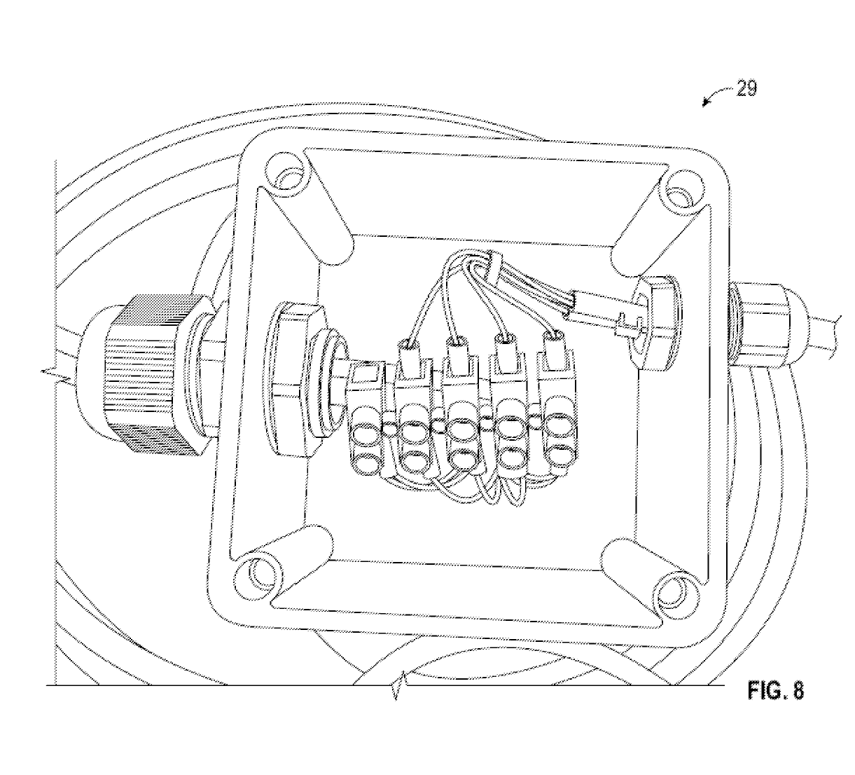

FIG. 7 shows the interior of the user interface box 44 and shows how it receives cabling from the junction box 29 and a power cable 48 which contains an earth conductor and a conductor for connection to power rail 31.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

For example, although in a preferred embodiment of the invention the trailer sensor 28 comprises a tilt sensor other arrangements are possible. For example, a trailer proximity sensor might be mounted to the top of top plate 16 for sensing the proximity of a trailer skid plate. Furthermore, although in the preferred embodiment of the invention the locking sensor comprises a locking handle sensor that is arranged to sense the position of a handle that locks the locking jaws, in other embodiments the locking sensor might directly sense the locking of the jaws, or other components of the turntable's locking mechanism, within the turntable.

The invention is, therefore, claimed in any of its forms or modifications within the proper scope of the appended claims appropriately interpreted by those skilled in the art.

We claim:

1. A turntable assembly for coupling a prime mover to a trailer including:
a locking sensor arranged to sense that a locking mechanism of the turntable is in a locked configuration; and
a user interface located remote from the locking sensor and in communication therewith;
wherein the communication interface is arranged for indicating that the locking mechanism has assumed the locked configuration to an operator.

2. An assembly according to claim 1, wherein the locking sensor comprises a locking handle sensor that is arranged to sense the position of a locking handle that operates the locking mechanism.

3. An assembly according to claim 1, further including a kingpin sensor arranged to sense location of a kingpin within the turntable at a position for correct coupling.

4. An assembly according to claim 3, wherein the king pin sensor is in communication with the user interface.

5. An assembly according to claim 1 including a trailer sensor which is arranged to sense a portion of a trailer in proximity to the turntable for coupling thereto.

6. An assembly according to claim 5, wherein the trailer sensor comprises a tilt sensor in communication with the user interface wherein the tilt sensor is arranged to sense a tilt of the turntable associated with a coupling status of the turntable.

7. An assembly according to claim 1, wherein the user interface comprises at least one light source and at least one audible alert source.

8. An assembly according to claim 7, wherein said light source and said audible alert source are coupled to said sensor(s) by control circuitry wherein the control circuitry is arranged to operate said light source and said alert source until said sensor(s) indicate correct coupling of the kingpin with the turntable.

9. An assembly according to claim 2, further including a kingpin sensor arranged to sense location of a kingpin within the turntable at a position for correct coupling.

10. An assembly according to claim 9, wherein the king pin sensor is in communication with the user interface.

11. An assembly according to claim 10 including a trailer sensor which is arranged to sense a portion of a trailer in proximity to the turntable for coupling thereto.

12. An assembly according to claim 11, wherein the trailer sensor comprises a tilt sensor in communication with the user interface wherein the tilt sensor is arranged to sense a tilt of the turntable associated with a coupling status of the turntable.

13. An assembly according to claim 12, wherein the user interface comprises at least one light source and at least one audible alert source.

14. An assembly according to claim 13, wherein said light source and said audible alert source are coupled to said sensor(s) by control circuitry wherein the control circuitry is arranged to operate said light source and said alert source until said sensor(s) indicate correct coupling of the kingpin with the turntable.

15. An assembly according to claim 14, wherein the control circuitry comprises at least one relay.

16. A coupling monitoring system for a turntable of a type used to couple a prime mover to a trailer, said monitoring system including:
a locking sensor arranged to sense that a locking mechanism of the turntable is in a locked configuration; and
a user interface located remote from the locking sensor and in communication therewith
wherein the communication interface is arranged for indicating that the locking mechanism has assumed the locked configuration to an operator.

17. A monitoring system according to claim 16, wherein the locking sensor comprises a locking handle sensor that is arranged to sense the position of a locking handle that operates the locking mechanism.

18. A coupling monitoring system according to claim 16, wherein the turntable further comprises a kingpin sensor arranged to sense location of a kingpin within the turntable at a position for correct coupling.

19. A coupling monitoring system according to claim 18, wherein the king pin sensor is in communication with the user interface.

20. A method for assisting in the coupling of a semi-trailer to a turntable of a prime mover including:
remotely monitoring sensors about the turntable to:
determine that the semitrailer is suitably close to the turntable for correct coupling;
determine that a locking member of the semitrailer is correctly positioned relative to the turntable for correct coupling; and
determining that a kingpin locking mechanism of the turntable is in a locked configuration;
wherein the result of the determinations is indicated to an operator of the prime mover.
